(19) United States
(12) Patent Application Publication
(10) Pub. No.: US 2007/0079804 A1
(43) Pub. Date: Apr. 12, 2007

(54) WORKING MACHINE FUEL MANAGEMENT SYSTEM AND FUEL MANAGING METHOD

(75) Inventor: Tetsuya Nakayama, HIRATSUKA-SHI, KANAGAWA (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: KOMATSU LTD., TOKYO (JP)

(21) Appl. No.: 10/577,719

(22) PCT Filed: Nov. 5, 2004
(86) PCT No.: PCT/JP04/16398

§ 371 Date: May 2, 2006

(30) Foreign Application Priority Data
Nov. 10, 2003 (JP) 2003-379775

(51) Int. Cl. G08B 21/18

(52) U.S. Cl. 123/339.15

(57) ABSTRACT

A fuel management system detects theft of fuel from the fuel tank (81) of a working machine (1) or insertion of foreign matter into the fuel tank, and issues an alarm. The total operating hours of the working machine (1) and the actual volume and weight of the contents of the fuel tank (81) are measured immediately after the start and stop of the working machine (1), and transmitted to a server (10) which calculates the fuel consumption amount from the total operating hours, calculates the volume and weight of the fuel assumed to remain in the fuel tank (81) from the fuel consumption amount, and compares the calculated volume and weight with the actual volume and weight. If a large difference is detected in the volume or weight, an alarm is transmitted to a user terminal (20) and to the working machine.

### TECHNICAL FIELD

The present invention relates to a system and a method for managing the fuel for a working machine such as a machine for construction or haulage work or the like.

### BACKGROUND ART

Management systems are known (Patent Document #1: Japanese Patent Laid-Open Publication 2002-91547 shows an example) which perform centralized management of the operational states of large numbers of working machines such as construction machines or haulage vehicles or the like which are present in several locations. With such a management system, various sensors are mounted on each working machine, and, based upon the detection signals from those sensors, operational data is generated for that working machine (for example, operating time, engine rotational speed, battery voltage, engine cooling water temperature, remaining amount of fuel, and the like). The operational data for those working machines are collected together by a server via a computer network which includes a wireless communication network. The server accumulates the operational data for the working machines, and performs supply of this operational data to a user terminal, changes control setting values of the working machines according to the operational data, and the like, automatically. The operational data which is supplied to the user may be utilized for the purpose, for example, of managing the refueling time from the fuel remaining amount, and the like.

Patent Document #1: Japanese Patent Laid-Open Publication 2002-91547.

### DISCLOSURE OF THE INVENTION

With many working machines, it is often the case that they are left unattended on a construction site until a predetermined job has been completed, and sometimes it may happen that they are subjected to damage such as extraction of fuel during the night, or placing foreign matter like sand or water or the like into the fuel tank, or the like. However, although with a prior art managing system it is possible to show the most recent remaining amount of fuel, it is not possible to supply information which will enable it to be decided whether damage such as theft of fuel or the like has occurred.

The object of the present invention is to provide a fuel management system for a working machine, which can more reliably perceive an anomaly of the fuel or of the fuel tank of the working machine.

According to a first aspect of the present invention, a system for managing fuel for a working machine includes: tank contents amount measurement means which measures the amount of contents in a fuel tank of the working machine; operational value measurement means which measures a predetermined operation value related to fuel consumption operation of the working machine; remaining fuel amount calculation means which calculates an expected remaining fuel amount, which is the amount of remaining fuel which ought to be present within the fuel tank, based on the measurement value from the operational value measurement means; amount comparison means which compares the amount of contents which has been measured by the tank contents amount measurement means, with the expected remaining fuel amount which has been calculated by the remaining fuel amount calculation means; and alarm issue means which issues an alarm in response to the amount comparison means.

In a preferred embodiment, in addition to the above described structure, there is further included refueling amount determination means which obtains the actual or scheduled refueling amount, when refueling of the fuel tank is actually executed, or when scheduled to be executed. And the above described remaining fuel amount calculation means is arranged to calculate the expected remaining fuel amount, based on the measurement value from the above described operational value measurement means, and the refueling amount which has been obtained by the above described refueling amount determination means.

In a preferred embodiment, the operational value measurement means measures operating hours of the working machine. And the remaining fuel amount calculation means calculates a fuel consumption amount from the operating hours which have been measured, and calculates the expected remaining fuel amount from the fuel consumption amount which has thus been calculated. As a variant embodiment, it may be arranged for a fuel injection amount of an engine of the working machine to be calculated or measured, and for a fuel consumption amount to be calculated from this fuel injection amount which has been calculated or measured.

In a preferred embodiment, the above described tank contents amount measurement means measures the volume of the contents in the fuel tank, and the above described remaining fuel amount calculation means calculates the expected volume of the remaining fuel which ought to be present in the fuel tank. Accordingly, the above described amount comparison means compares the volume of the contents in the tank which has been measured, with the expected remaining fuel volume which has been calculated. If the result of this comparison is that the difference between these two volumes is greater than a predetermined value, then an electronic alarm is issued, and this alarm is transmitted to the user of the working machine, and/or to the working machine. Furthermore, the weight of the contents in the tank is measured, the expected weight of the remaining fuel is calculated from the above described volume of the contents in the tank and the previously known specific gravity of the fuel, and the weight of the contents in the tank which has thus been measured and the expected weight of the remaining fuel which has been thus calculated are compared. And, as well, if the result of this comparison is that the difference between these two weights is greater than a predetermined value, then an electronic alarm is issued.

As a variant embodiment, it would also be acceptable to arrange to decide whether or not to issue an alarm, by the above described tank contents amount measurement means measuring the weight of the contents in the fuel tank, by the above described remaining fuel amount calculation means calculating the expected weight of the remaining fuel which ought to be present in the fuel tank, and by the weight of the contents in the tank which has been measured, and the expected remaining fuel weight which has been calculated, being compared. Furthermore, it would also be acceptable to measure the volume of the contents in the fuel tank, to calculate the expected volume of the remaining fuel from the weight which has been measured by the above described tank contents amount measurement means and the previously known specific gravity of the fuel, to compare the volume of the contents in the tank which has thus been measured with the expected volume of the remaining fuel which has been thus calculated, and to arrange to decide whether or not to issue an alarm according to the result thereof.

In a preferred embodiment, the above described processing is performed immediately after the working machine (1) starts and immediately after it stops. As a variant embodiment, the above described processing may be performed periodically at a predetermined time interval.

According to another aspect of the present invention, a method for managing the fuel of a working machine includes: a step of measuring the amount of contents in a fuel tank of the working machine; a step of measuring a predetermined operation value related to fuel consumption operation of the working machine; a step of calculating an expected remaining fuel amount, which is the amount of remaining fuel which ought to be present within the fuel tank, based on the result of measurement of the operational value; a step of comparing the amount of contents which has been measured, with the expected remaining fuel amount which has been calculated; and a step of issuing an alarm in response to the comparison result.

According to the present invention, it is possible more reliably to perceive an anomaly of the fuel or of the fuel tank of a working machine.

### BRIEF DESCRIPTION OF THE DRAWINGS

FIG. 1 is a schematic figure showing the overall structure of a fuel management system of a working machine according to an embodiment of the present invention;

FIG. 2 is a block diagram showing the structure of a portion related to the management of fuel of the working machine;

FIG. 3 is a block diagram showing the functional structure of a server 10;

FIG. 4 is a figure showing an example of a refueling schedule table 91;

FIG. 5 is a figure showing an example of a fuel consumption amount table 92; and

FIG. 6 is a flow chart showing the flow of control in the server 10.

### BEST MODE FOR CARRYING OUT THE INVENTION

In the following, embodiments of the present invention will be explained based on the drawings.

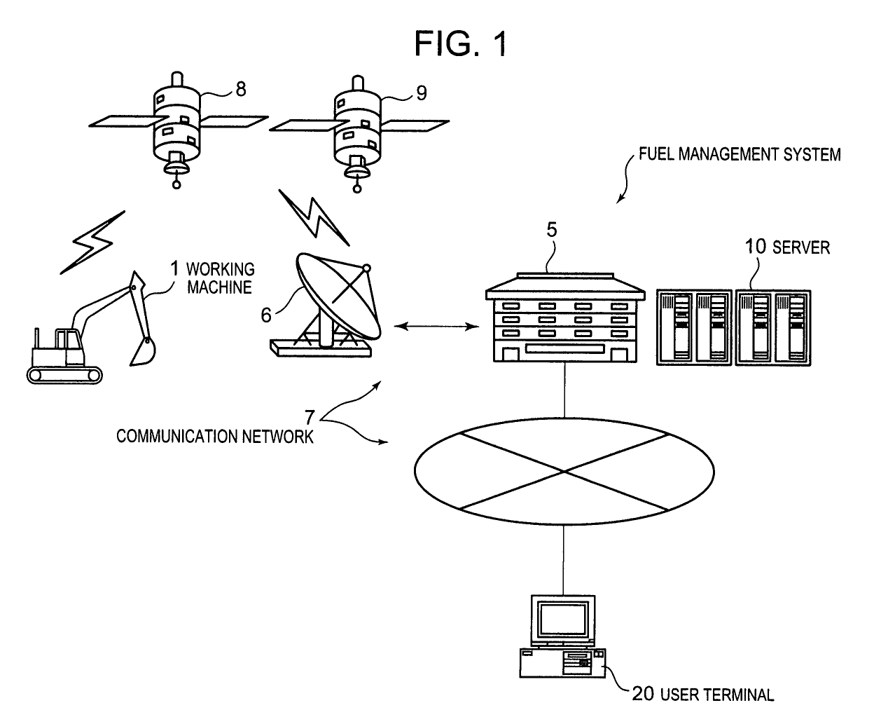

FIG. 1 is a schematic figure showing the schematic structure of a fuel management system of a working machine according to this embodiment.

The fuel management system of this embodiment is arranged to decide if there has been theft of the fuel of a working machine 1, and, if theft has taken place, to issue an alarm. This fuel management system reliably detects whether fuel has been extracted during the period from the termination of working on one day to the start of working the next day, or refueling has not taken place although refueling was scheduled, or foreign material has been put into the fuel tank in order to conceal the extraction of fuel.

In FIG. 1, a fuel management system comprises a working machine 1, a server 10 which is provided in a network control bureau 5 on the side of the working machine maker, a user terminal 20 which is provided on the side of a user of the working machine 1 (or on the side of a sales outlet), and a communication net 7 which links these together. Here, the communication net 7 may consist of a satellite communication circuit which links the working machine 1 and a satellite earth station 6 via a communication satellite 8, a ground communication circuit which links the satellite earth station 6 and the server 10 of the network control bureau 5, and a computer network such as an intranet or the internet or the like which links the server 10 and the user terminal 20.

Although only one working machine 1 and one user terminal 20 are shown in the figure, a plurality of each of them may actually be present. In the many types of working machines 1, there may be included construction machines such as hydraulic shovels, wheel loaders, bulldozers, motor graders, cranes and the like, haulage vehicles such as dump trucks or the like, and many types of industrial machinery such as demolition equipment or generating equipment or the like. Either one or a plurality of the servers 10 maybe provided. By performing centralized processing or distributed processing with one or a small number of servers 10, it is possible to monitor many types of working machine 1, and to supply information to many user terminals 20.

A general purpose personal computer which can execute various types of application software on an OS (Operating System) may be used for the user terminal 20. In such application software, there is included a web browser which displays WWW documents which are supplied by the server 10, an electronic mailer which performs sending and receipt of electronic mail, and the like.

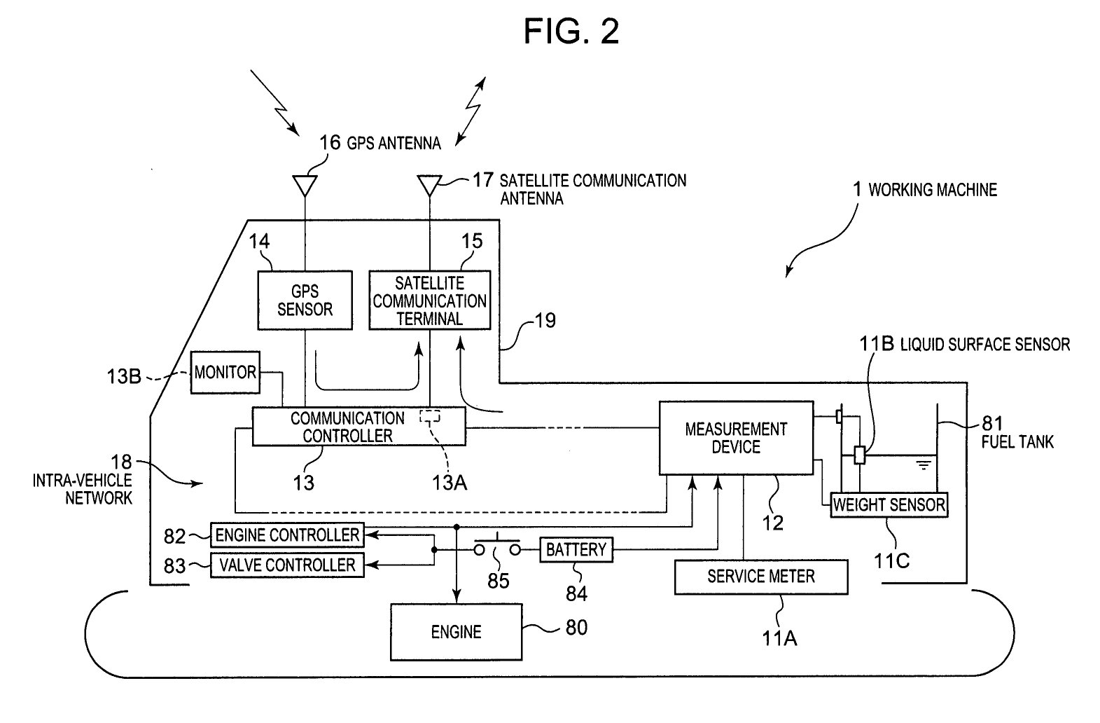

FIG. 2 shows the structure of a portion of the working machine 1 related to fuel management.

As shown in FIG. 2, the working machine 1 comprises an engine 80, a fuel tank 81 which holds fuel for the engine 80, a engine controller 82 which controls the engine 80, a valve controller 83 which controls a hydraulic system (not shown in the figure0 which is driven by the engine 80, a battery 84 which supplies electrical power to the engine controller 82 and the valve controller 83 and other electrical components, a key switch 85 which is turned on by actuation of an ignition key by the operator, and soon. Furthermore, the working machine 1 comprises an intra-vehicle network 18. This intra-vehicle network 18 includes a measurement device 12 which measures the state of various parts of the working machine 1, a communication controller 13 which is connected to the measurement device 12, a GPS (Global Positioning System) sensor 14 which is connected to the communication controller 13, a satellite communication terminal 15 which is connected to the communication controller 13, and the like. The GPS sensor 14 comprises a GPS antenna 16 for receiving electromagnetic waves from a GPS satellite 9 (see FIG. 1). The satellite communication terminal 15 comprises a satellite communication antenna 17 for communicating with the communication satellite 8 (see FIG. 1).

The measurement device 12 is connected to various sensors which are attached to the engine 80 of the working machine 1, to its fuel tank 81, to its battery 84, and to various other types of component. These various sensors include a service meter (operating hours integrator) 11A, a liquid surface sensor 11B, and a fuel weight sensor 11C. The service meter 11A counts and integrates the operating hours of the working machine 1, and outputs a detection signal which gives the total operating hours. The liquid surface sensor 11B measures the height of the surface of the liquid contents of the fuel tank 81 and outputs a detection signal which gives the actual volume of the contents of the fuel tank 81 (in this specification, this will be abbreviated as “tank contents actual volume”). The weight sensor 11C measures the actual weight of the fuel tank 81 and outputs a detection signal which gives the actual weight of the contents of the fuel tank 81 (in this specification, this will be abbreviated as “tank contents actual weight”). Now, although normally only fuel is put into the fuel tank 81, it sometimes may be the case that foreign matter is mixed thereinto. Accordingly, although normally the tank contents actual volume and the tank contents actual weight which are detected by the liquid surface sensor 11B and by the fuel weight sensor 11C respectively give the actual volume and the actual weight of the remaining fuel in the fuel tank 81, if some foreign matter has been mixed in, then they become different values from the actual volume and the actual weight of the remaining fuel. In the sensors which are connected to the measurement device 12, further, there are included a cooling water temperature sensor which detects the temperature of the cooling water of the engine 80, an engine rotational speed sensor which detects the rotational speed of the engine 80, a fuel injection amount sensor which measures the fuel injection amount of the engine 80 based on a governor rack position signal of the engine 80, a battery voltage sensor which detects the output voltage of the battery 84, and the like, although these are not shown in the figure.

By using the satellite communication terminal 15, the measurement device 12 can perform bi-directional communication with the server 10 via a satellite communication circuit. The measurement device 12 receives the detection signals from the various sensors described above, and generates information which indicates various states of the working machine 1. In this information which is thus generated by the measurement device 12, there are included operating hours information which indicates the total operating hours, volume information which indicates the tank contents actual volume, weight information which indicates the tank contents actual weight, temperature information which indicates the engine cooling water temperature, rotational speed information which indicates the engine rotational speed, injection amount information which indicates the fuel injection amount, voltage information which indicates the battery voltage, and the like. In the following explanation, these items of information will collectively be referred to as “machine information”.

The measurement device 12 periodically generates the newest machine information and sends it to the communication controller 13. Furthermore, the engine controller 82 and the valve controller 83 acquire some predetermined items of information among the machine information from the measurement device 12, and perform their respective control operations by processing those items of information.

The communication controller 13 is, for example, a micro computer, and the measurement device 12 controls the satellite communication terminal 15, and is able to perform bi-directional communication with the server 10 via the satellite communication circuit. Periodically or as required, the communication controller 13 receives the newest above described machine information from the measurement device 12, and is endowed with the function of outputting it to the server 10 on the satellite communication circuit via the satellite communication terminal 15. Together with the machine information, the communication controller 13 also sends to the server 10 position information indicating the current position, which it has received from the GPS sensor 14.

It is arranged for the measurement device 12, the liquid surface sensor 11B, the weight sensor 11C, the communication controller 13, the GPS sensor 14, and the satellite communication terminal 15 to be always supplied with electrical power from the battery 84, i.e. not via the key switch 85. Accordingly, among the above described machine information, in particular, the volume information and the weight information which show the actual volume and the actual weight of the contents of the tank can be ascertained by the measurement device 12 and can be notified to the communication controller 13 at any time, irrespective of whether the engine 80 is operating or not, and can be notified to the server 10 via the satellite communication net. In this embodiment, it is arranged for the communication controller 13 to acquire the newest volume information and weight information from the measurement device 12 at least directly after the engine is started and directly after it has been stopped, and to transmit them to the server 10.

The communication controller 13 comprises a storage device 13A, and therein there are stored the name of the user of the working machine 1, a working area which is set in advance, and also the history of the above described machine information and position information during a most recent constant time period in the past and the like. Here, the working area is a predetermined ground range within which it is permitted for this working machine to be located. The fact that the working machine 1 has gone outside the working area, means that there is a possibility that theft of the working machine 1 has occurred. This working area is not only stored in the communication controller 13 within the working machine 1, but also in the server 10 and the user terminal 20, and is stored in correspondence with the working machine 1. The server 10 decides whether or not the working machine 1 is located outside the working area, based on the position information which it has received from the working machine 1. And if the result is that it has been decided that the working machine 1 is present outside the working area, then the server 10, according to requirements, is able to lock the working machine 1 (for example, may make it impossible to start it even though the ignition key is inserted and an attempt is made at starting) by transmitting a lock command via the satellite communication circuit to the working machine 1.

Furthermore, a monitor 13B is also connected to the communication controller 13. As this monitor 13B, for example, there may be used a map display for car navigation based on the position information from the GPS sensor 14, or the like.

Directly after the working machine 1 is started and directly after it has been stopped, the server 10 of the network control bureau 5 (see FIG. 1) receives the machine information which is sent via the communication net 7 from the working machine 1, stores it, and is arranged, by analyzing this machine information (particularly, the above described volume information and weight information), to decide if there is a possibility that fuel has been extracted from the working machine 1, or if refueling has not been performed according to the refueling schedule, or if in order to conceal the extraction of fuel, some foreign matter has been mixed into the fuel tank. And, if the server 10 has decided that there is this type of possibility, it is arranged for it to transmit an alarm to the user terminal 20 via the communication net 7.

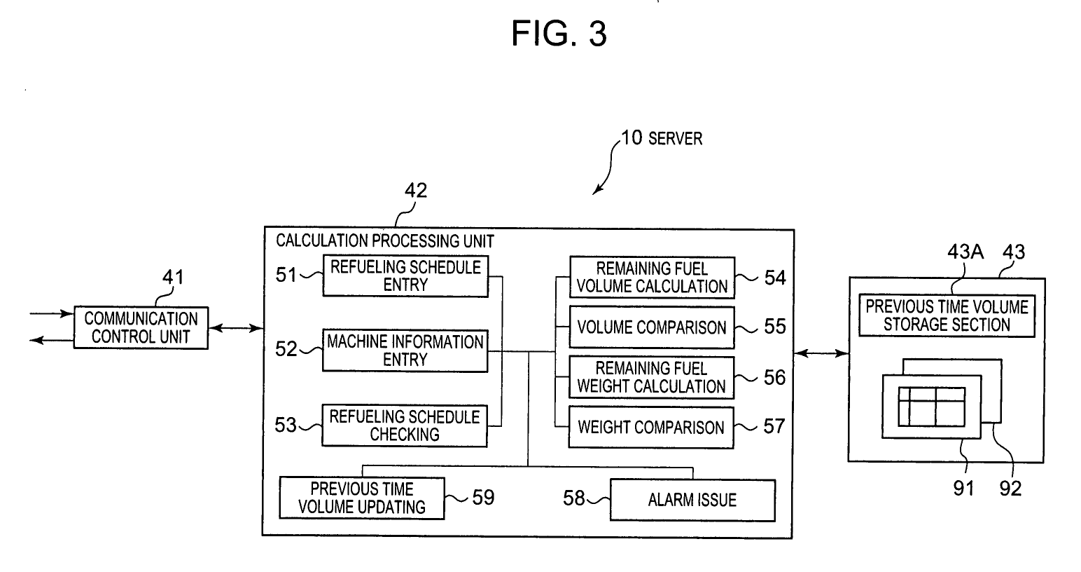

FIG. 3 shows the functional structure of the server 10.

As shown in FIG. 3, the server 10 comprises a communication control unit 41 which controls communication with the communication net 7, a calculation processing unit 42, which for example includes a micro processor, and which processes information which is received and transmitted via the communication control unit 41, and a storage device 43 which may consist of a magnetic storage device or the like.

In the storage device 43, although this is not shown in the figure, there are stored a computer program which is executed by the calculation processing unit 42, and a data base in which are entered the machine information which has been received from the working machine 1 and analysis results of this machine information and the like. And, as shown in FIG. 3, in this data base in the storage device 43, there are included a previous time volume storage section 43A, a refueling schedule table 91, a fuel consumption amount table 92, and the like. This previous time volume storage section 43A, refueling schedule table 91, and fuel consumption amount table 92 are provided for each working machine 1. In the previous time volume storage section 43A, there is entered the volume information within the operating information which was received from the working machine 1 the previous time, in other words, the tank contents actual volume for the previous time when the machine information was received. It should be understood that, as will be described hereinafter, the value of the tank contents actual volume for the previous time which is entered in this previous time volume storage section 43A is updated so as to increase by just the scheduled refueling amount, each time the scheduled refueling day arrives. This refueling schedule table 91 and fuel consumption amount table 92 are explained below.

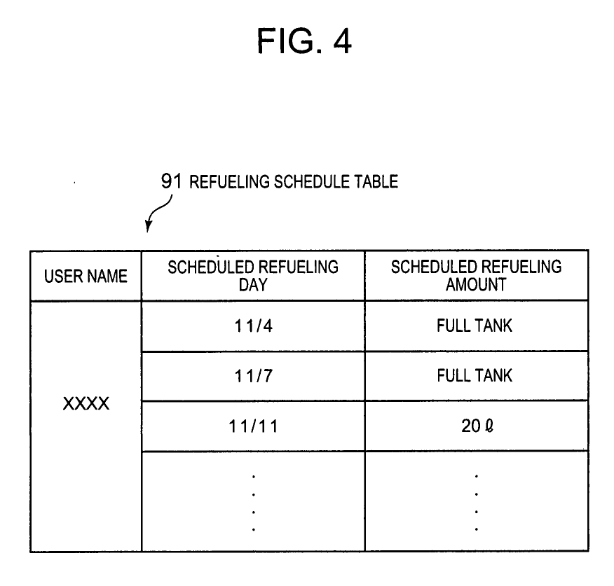

FIG. 4 shows an example of the refueling schedule table 91.

In this refueling schedule table 91, there is entered refueling schedule information which gives the refueling schedule for the working machine 1. In this refueling schedule information, for example, as shown in FIG. 4, there may be included a scheduled day for refueling the working machine 1, a scheduled refueling amount (this means the scheduled volume of fuel to be supplied into the fuel tank 81 (“full tank” means that fuel is supplied until the fuel tank 81 becomes full)), and the like. When the user of the working machine 1 inputs the refueling schedule information for the working machine 1 to his user terminal 20, this refueling schedule information which he has inputted is transmitted from the user terminal 20 to the server 10. The server 10 enters this refueling schedule information which it has received from the user terminal 20 into the refueling schedule table 91 in correspondence with the working machine 1.

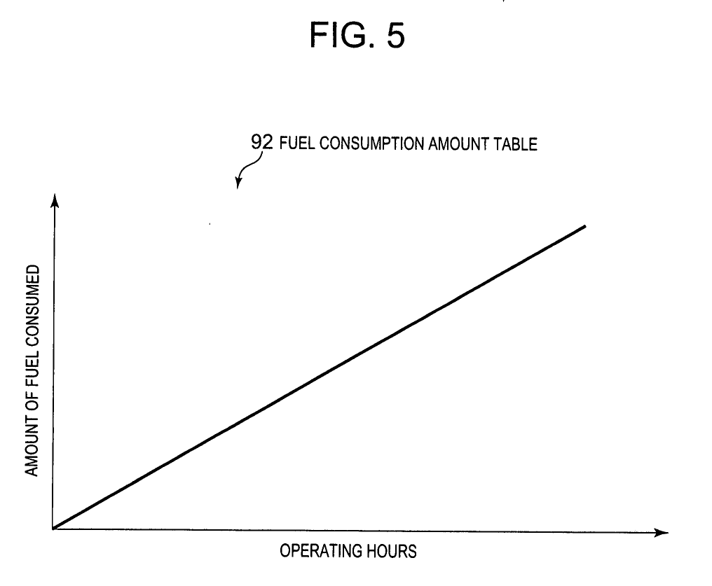

FIG. 5 shows an example of the fuel consumption amount table 92.

In this fuel consumption amount table 92, the volume of fuel which is consumed by the working machine 1 (its fuel consumption amount) is defined as a function of the operating hours. This fuel consumption amount table 92 is used for calculating the volume of fuel which ought to have been consumed by the working machine 1 (in other words, the expected value of its fuel consumption amount) from when the machine information was received the previous time until when it is received this time, based on the operating hours information which has been transmitted from the working machine 1. It should be understood that, as a method of calculation for the expected value of the fuel consumption amount, instead of using a lookup table like the fuel consumption amount table 92, it would also be acceptable to use a calculation function which was set in advance (for example, a calculation equation in which a predetermined coefficient which gives a standard fuel consumption amount per unit time is multiplied by the length of the operating time which has been measured).

Referring again to FIG. 3, by executing a computer program within the storage device 43, the calculation processing unit 42 performs are fueling schedule entry process 51, a machine information entry process 52, a refueling schedule checking process 53, a remaining fuel volume calculation process 54, a volume comparison process 55, a remaining fuel weight calculation process 56, weight comparison means 57, alarm issue means 58, and a previous time volume updating process 59. In the following, the above described processes 51 through 59 will be explained.

The refueling schedule entry process 51 is a function which receives the refueling schedule information which is transmitted from the user terminal 20 (the scheduled refueling day and the scheduled refueling amount and so on), and enters this refueling schedule information in the refueling schedule table 91.

The machine information entry process 52 is a function which receives the machine information which is transmitted from the working machine 1, and enters this machine information which has been received in a data base within the storage device 43. Particularly, the operating hours information and the volume information and the weight information within this machine information which has been received will be analyzed by the server 10 in order to decide upon theft of fuel from the fuel tank 81 and as to whether there is foreign matter mixed in to the fuel tank 81.

The refueling schedule checking process 53 is a function which decides whether or not each scheduled refueling day has been passed, based on the refueling schedule table 91, and, each time the scheduled refueling day has been passed, starts the previous time volume updating process 59. And the previous time volume updating process 59 is a function which adds the scheduled refueling amount corresponding to this scheduled refueling day to the tank contents actual volume the previous time which is entered in the previous time volume storage section 43A, and which updates the previous time volume storage section 43A by again entering this added value in the previous time volume storage section 43A. If the scheduled refueling amount is “full tank”, a value which is equal to the maximum capacity of the fuel tank 81 is again entered in the previous time volume storage section 43A.

The remaining fuel volume calculation process 54 is a function in which, each time the machine information is received from the working machine 1, based on the operating hours information in this machine information which has been received, the length of the operating hours of the working machine 1 from when the information was received the previous time to when the information was received this time is calculated, and, by referring to the fuel consumption amount table 92 based on the length of the operating hours which has been thus calculated, the volume of fuel (the fuel consumption amount) which ought to have been consumed by the working machine 1 from when the information was received the previous time to when the information was received this time is obtained, and the remaining fuel volume in the fuel tank 81 is calculated by subtracting this fuel consumption amount which has thus been calculated from the previous time tank contents volume value which is entered in the previous time volume storage section 43A. In this specification, the remaining fuel volume which has been calculated by the remaining fuel volume calculation process 54 in the above described manner is termed the “expected remaining fuel volume”. This expected remaining fuel volume ought to agree with the tank contents actual volume which is indicated by the volume information received from the working machine 1, provided that no theft of fuel from the fuel tank 81 and no mixing in of foreign matter into the fuel tank 81 is performed, and moreover that refueling is performed according to the schedule.

The volume comparison process 55 is a function in which the expected remaining fuel volume which was calculated by the remaining fuel volume calculation process 54 and the tank contents actual volume which was indicated by the volume information received from the working machine 1 are compared. If the result of this comparison is that a large discrepancy of a certain magnitude between the expected remaining fuel volume and the tank contents actual volume is detected, then there is a possibility that fuel has been stolen from the fuel tank 81, or that refueling has not been performed according to the schedule.

The remaining fuel weight calculation process 56 is a function in which the weight of the remaining fuel within the fuel tank 81 is calculated by multiplying the tank contents actual volume given by the volume information which has been received from the working machine 1 by the specific gravity value of the fuel, which is set in advance. In this specification, the remaining fuel weight which has been calculated by the remaining fuel volume calculation process 54 in the above described manner is termed the “expected remaining fuel weight”. This expected remaining fuel weight ought to agree with the tank contents actual weight which is given by the weight information received from the working machine 1, provided that the only substance contained in the fuel tank 81 is fuel.

The weight comparison process 57 is a function in which the expected remaining fuel weight which has been calculated by the remaining fuel weight calculation process 56 and the tank contents actual weight given by the weight information which has been received from the working machine 1 are compared. If the result of this comparison is that a large discrepancy of a certain magnitude between the expected remaining fuel weight and the tank contents actual weight is detected, then there is a possibility that foreign matter has been mixed into the fuel tank 81.

The alarm issue process 58 is a function in which, if in response to the result of the volume comparison process 55 and the result of the weight comparison process 57, a large discrepancy greater than or equal to a predetermined value has been detected between the expected remaining fuel volume and the tank contents actual volume, or between the expected remaining fuel weight and the tank contents actual weight, then an electronic alarm is transmitted to the user terminal 20 by electronic mail, or by some other method, via the communication net 7. In this alarm issue process 58, an electronic alarm may be transmitted, not only to the user terminal 20, but also to the working machine 1 via the satellite communication net, and it may be arranged to display the details of this alarm on the monitor 13B of the working machine 1.

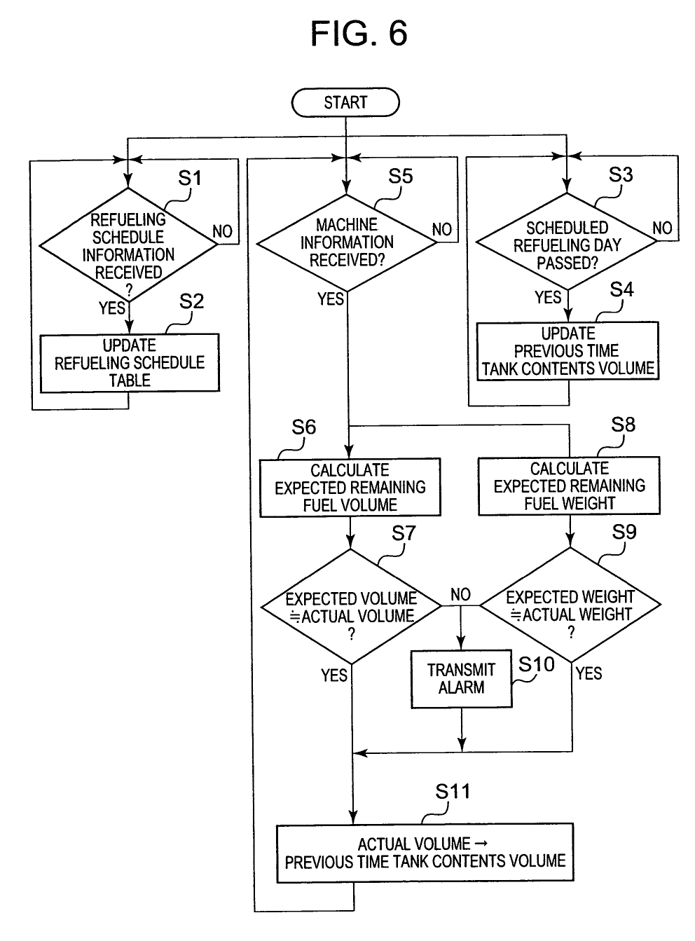

FIG. 6 shows the flow of the control performed by the server 10.

Steps S1, S2: when the refueling schedule information is inputted by the user to his user terminal 20, the refueling schedule information entry process 51 receives this refueling schedule information from the user terminal 20, and updates the refueling schedule table 91 by entering this refueling schedule information which has been received in the refueling schedule table 91.

Steps S3, S4: The previous time volume updating process 59 refers to the refueling schedule table 91, and checks whether a scheduled refueling day has been passed. When the result of the check is that a scheduled refueling day has passed, then the previous time volume updating process 59 reads the scheduled refueling amount which corresponds to this scheduled refueling day from the refueling schedule table 91, adds this scheduled refueling amount to the previous time tank contents volume which is stored in the previous time remaining amount storage section 43A, and updates the previous time tank contents volume which is entered in the previous time remaining amount storage section 43A by re-entering this added value as the previous time tank contents volume in the previous time remaining amount storage section 43A.

Step S5: When the machine information is transmitted from the working machine 1, the machine information entry process 52 receives this machine information, and enters it in the data base. As described previously, the working machine 1 may transmit the machine information, for example, directly after the engine is started and directly after the engine is stopped. Accordingly, the machine information from the working machine 1 is received by the server 10 from almost twice per day to several times per day (for example, when working is started in the morning and when it is stopped, and when working is started in the afternoon and when it is terminated)

By the way, it may be arranged for the refueling schedule checking process 53 of the above described step S3 to be executed in response to the fact that the machine information has been received in the step S5. Normally the refueling is performed in the state with the engine stopped. The updating in the step S4 of the previous time remaining amount storage section 43A comes to be performed when the engine is initially started on the day after refueling has been performed.

Step S6: When the machine information is received in the step S5 from the working machine 1, the remaining fuel volume calculation process 54 calculates the expected remaining fuel volume in the following manner. In detail, the length of the operating hours of the working machine 1 between from when the machine information was received the previous time to when the machine information has been received this time is calculated from the operating hours information within the machine information which has been received in the step S5. The fuel consumption amount corresponding to the length of the operating hours which has been calculated is calculated by referring to the fuel consumption amount table 92. This fuel consumption amount which has thus been calculated is subtracted from the previous time tank contents volume which is stored in the previous time volume storage section 43A, and the remaining value is taken as being the expected remaining fuel volume. As described previously, provided that no theft of fuel from the working machine 1 has occurred, and that refueling has not been forgotten or the like, this expected remaining fuel volume ought almost to agree with the tank contents actual volume which is given by the volume information within the machine information which has been received.

Step S7: When the expected remaining fuel volume is calculated, the volume comparison process 55 compares this expected remaining fuel volume with the tank contents actual volume which is given by the volume information which has been received. If the result of this comparison is that there is a large difference greater than or equal to a predetermined value between the two of them (in particular, if the expected remaining fuel volume is greater than the tank contents actual volume by a predetermined value or greater), then this means that there is a possibility that fuel has been extracted from the fuel tank 81, or that refueling has not been performed on the scheduled refueling day. If this type of anomaly has been detected, then the flow of control proceeds to the step S10.

By the way, it would also be acceptable to arrange not to decide right away that an anomaly has occurred, if the result of the above described comparison is that the expected remaining fuel volume is less than the tank contents actual volume, even if the difference between them is greater than or equal to the predetermined value. This is because, if refueling is performed on the scheduled refueling day, this type of comparison result appears during this scheduled refueling day. If this type of comparison result has appeared, whether the above described difference is due to refueling, or whether it is due to an anomaly, will become clear when initially machine information is received on the next day.

Step S8: Furthermore, when the machine information is received in the step S5 from the working machine 1, the remaining fuel weight calculation process 56 calculates the expected remaining fuel weight in the following manner. In detail, the tank contents actual volume which is given by the volume information which has been received is multiplied by the specific gravity value of the fuel which is set in advance, and this product value is taken as being the expected remaining fuel weight. As described previously, provided that the substance contained in the fuel tank 81 is only fuel, this expected remaining fuel weight ought to agree with the tank contents actual weight which is given by the weight information within the machine information which has been received.

Step S9: When the expected remaining fuel weight is calculated, the weight comparison process 57 compares this expected remaining fuel weight with the tank contents actual weight which is given by the volume information which has been received from the working machine 1. If the result of this comparison is that there is a large difference greater than or equal to a predetermined value between the two of them, then this means that there is a possibility that foreign matter has been mixed into the fuel tank 81. If this type of anomaly has been detected, then the flow of control proceeds to the step S10.

Step S10: If an anomaly has been detected in the above described step S7 or S9, if an estimated remaining amount and an actual remaining amount do not agree, then the alarm issue process 58 transmits an electronic alarm to the user terminal 20 and/or the working machine 1 showing the details of the anomaly which has been detected. The details of this alarm are displayed on the display screen of the user terminal 20, and/or on the monitor 13B of the working machine 1.

Step S11: Whether an anomaly has been detected in the above described step S7 or S9 or no anomaly has been detected, the flow of control proceeds to the step S11, and herein the previous time volume updating process 59 enters the tank contents actual volume which is given by the volume information which has been received into the previous time volume storage section 43A as the new value for the previous time tank contents actual volume.

According to this type of embodiment, the following beneficial effects are available.

(1) It is possible to detect whether fuel has been extracted from the fuel tank 81 by comparing the actual volume of the substance contained in the fuel tank 81 with the expected volume of fuel which really ought to remain, which has been calculated from the fuel consumption operation of the working machine 1. And, even if there has been a fuel leak, it is possible to detect this as well.

(2) Even if, after having taken fuel out from the fuel tank 81, foreign matter has been mixed in instead, it is possible to detect this fact by comparing the actual weight of the substance contained in the fuel tank 81 with the expected weight which it ought to have if the substance contained therein were only fuel.

(3) There is a beneficial effect for the prevention of crime, since, in response to the above described detection result, an electronic alarm is transmitted automatically to the user terminal 20 and/or the working machine 1 via the communication net.

(2) Since the above described detection operation is performed at two time points—directly after the engine is started, and directly after it is stopped—accordingly, if the above described theft has been detected, it is possible to specify whether it was performed while the engine of the working machine 1 was being operated, or whether it was performed while the working machine 1 was out of use and stopped; and this information serves a role in subsequent investigation.

(4) Since, in the calculation for the above described detection operation, the scheduled refueling amount according to the refueling schedule which is stored in the refueling schedule table 91 is included in the calculation, accordingly it is possible to detect when refueling has been forgotten. Since in response to this detection result an alarm is automatically transmitted to the user terminal 20 and/or the working machine 1, accordingly, even if refueling has been forgotten, it is possible to cause the operation to perform refueling without any large delay.

(5) Even while the engine is stopped, the working machine 1 can generate the machine information for the above described detection and transmit it to the server 10, so that it is possible for the alarm to be displayed from the server 10.

It should be understood that the present invention is not limited to this embodiment; it includes other structures and the like which are able to attain the objects of the present invention; and, moreover, variations such as those shown below or the like are also included in the present invention.

Te working machine 1 may transmit the machine information to the server 10 periodically at a predetermined interval, instead of transmitting not only immediately after the engine is started but also immediately after it is stopped. In particular, since it is possible to detect the extraction of fuel while it is actually taking place and to emit an alarm, if the transmission of machine information is repeated at a short interval such as for example around several minutes when the working machine 1 is out of use and stopped, accordingly the beneficial effect for the prevention of crime is higher. And, by calculating the rate of change of the volume or the weight of the substance in the tank at this type of short cycle, based on the machine information, it is also possible to make a decision as to whether theft of fuel or fuel leakage is occurring, from this rate of change.

The alarm may not only be transmitted to the user terminal 20 and the working machine 1, but may also be transmitted to some other relevant entity, such as a sales representative office or the like.

A portion or all of the above described processes 51 through 59 which have been executed by the server 10 may also be executed by the working machine 1 or the user terminal 20. For example, it would also be acceptable to arrange for a calculation processing device which is equipped to the working machine 1 (this may be the same device as the communication controller 13 or the measurement device 12, or may be a separate device from those) to execute all of the above described processes 51 through 59, and to display an alarm on the monitor 13B if an anomaly has been detected, and to transmit it from the satellite communication terminal 15 to the user terminal 20 and/or the server 10.

Communication between the working machine 1 and the server 10 need not only be via a satellite communication net; it would also be acceptable to perform it using some other mobile communication net, for example a portable telephone communication net.

As the method for calculating the fuel consumption amount of the working machine 1, instead of, or as well as, a method based on its operating hours, it would also be acceptable to utilize some other method. For example, it would also be acceptable to utilize a method of calculating and integrating the fuel injection amount based on a fuel injection control signal transmitted from the engine controller 82 to the engine 80, and thereby it would be possible to calculate the fuel consumption amount with greater accuracy.

It would also be acceptable to arrange, when refueling has been performed, for the operator to input accurate refueling information such as the actual refueling amount and the day and time of refueling and so on to the working machine 1 (For example, one incorporated with an inputting device is used as the monitor 13B for input from such a device.), for this refueling information which has been inputted from the working machine 1 to be transmitted to the server 10, and for the server 10 to utilize this refueling information in the above described calculation for detection.

In the above described embodiment, the expected amount of remaining fuel which ought to be present in the fuel tank 81 was calculated as the value of its expected volume, and this expected volume was compared with the actual volume which was measured, with an alarm being outputted according to the result of this comparison. Furthermore, the expected weight of the remaining fuel was calculated by multiplying the actual volume which was measured by the specific gravity of the fuel, and this expected weight was compared with the actual weight which was measured, with an alarm being outputted according to the result of this comparison. However, as a variant embodiment, it would also be acceptable for the type of processing as follows to be performed, in which the treatment of the volume and the weight is opposite to the above described embodiment. That is, the expected amount of fuel which ought to remain in the fuel tank 81 may be calculated as the value of its expected weight, and this expected weight may be compared with the actual volume which was measured, with an alarm being outputted according to the result of this comparison. Furthermore, the expected volume of the remaining fuel may be calculated by dividing the actual weight which was measured by the specific gravity of the fuel, and this expected volume may be compared with the actual volume which was measured, with an alarm being outputted according to the result of this comparison.

Although a preferred structure and method for implementing the present invention has been disclosed in the above description, the present invention is not to be considered as being limited thereby. In other words, although principally the present invention has been specifically shown and moreover explained in relation to specific embodiments, with regard to the above described embodiments, it would be possible for a person skilled in the art to add various changes to its methods, numerical values, and other detailed structures, without departing from the range of the technical concepts and objectives of the present invention. Accordingly, since the above description limited to the method and numerical values and so on disclosed above is one which was given by way of example, in order to simplify the explanation of the present invention, and is not to be considered as being limitative of the present invention, accordingly a description which falls outside a portion or of all of the limitations of those methods, numerical values and so on is also to be considered as being included in the present invention.

1. A fuel management system for a working machine (1), comprising:
tank contents amount measurement means (11B) which measures an amount of substance contained in a fuel tank (81) of said working machine (1);
operational value measurement means (11A) which measures a predetermined operational value related to fuel consumption operation of said working machine (1);
remaining fuel amount calculation means (54) which calculates an expected remaining fuel amount, which is an amount of remaining fuel which ought to be present within said fuel tank (81), based on a measurement value from said operational value measurement means (11A);
amount comparison means (55) which compares said amount of contents which has been measured by the tank contents amount measurement means (11B), with said expected remaining fuel amount which has been calculated by said remaining fuel amount calculation means (54); and
alarm issue means (58) which issues an alarm in response to said amount comparison means (55).

2. The fuel management system according to claim 1, further comprising refueling amount determination means (53, 59) which, when refueling of said fuel tank (81) is actually executed or when scheduled to be executed, obtains an actual or scheduled refueling amount, wherein,
said remaining fuel amount calculation means (54) calculates said expected remaining fuel amount, based on the measurement value from said operational value measurement means (11A), and said refueling amount which has been obtained by said refueling amount determination means (53, 59).

3. The fuel management system according to claim 1 or claim 2, wherein
said operational value measurement means (11A) measures operating hours of said working machine (1), and
said remaining fuel amount calculation means (54) calculates a fuel consumption amount of said working machine (1) from said operating hours which have been measured by said operational value measurement means (11A), and calculates said expected remaining fuel amount from said fuel consumption amount which has thus been calculated.

4. The fuel management system according to claim 1 or claim 2, wherein
said operational value measurement means calculates or measures a fuel injection amount of an engine of said working machine (1), and
said remaining fuel amount calculation means (54) calculates a fuel consumption amount of said working machine (1) from said fuel injection amount which has been calculated or measured by said operational value measurement means (11A), and calculates said expected remaining fuel amount from said fuel consumption amount which has thus been calculated.

5. The fuel management system according to claim 1, wherein
the tank contents amount measurement means (11B) measures a volume of said contents in said fuel tank (81), and
said remaining fuel amount calculation means (54) calculates an expected volume of said remaining fuel which ought to be present in said fuel tank (81).

6. The fuel management system according to claim 5, further comprising:
tank contents weight measurement means (11C) which measures weight of the contents in said fuel tank (81);
remaining fuel weight calculation means (56) for calculating an expected remaining fuel weight, which is weight of the remaining fuel which ought to be present within said fuel tank (81), based on the volume of said contents which has been measured by said tank contents amount measurement means (11B), and on a specific gravity of said fuel; and
weight comparison means (57) which compares the weight of said contents which has been measured by said tank contents weight measurement means (11C), with said expected remaining fuel weight which has been calculated by said remaining fuel weight calculation means (56), wherein
said alarm issue means (58) also issues an alarm in response to said weight comparison means (57).

7. The fuel management system according to claim 1, wherein
said tank contents amount measurement means measures weight of said contents in said fuel tank (81); and
said remaining fuel amount calculation means calculates expected weight of said remaining fuel which ought to be present in said fuel tank (81).

8. The fuel management system according to claim 7, further comprising:
tank contents volume measurement means which measures a volume of the contents in said fuel tank (81);
remaining fuel volume calculation means which calculates an expected remaining fuel volume, which is a volume of the remaining fuel which ought to be present within said fuel tank (81), based on the weight of said contents which has been measured by said tank contents amount measurement means, and on a specific gravity of said fuel; and
volume comparison means which compares the volume of said contents which has been measured by said tank content volume measurement means, with said expected remaining fuel volume which has been calculated by said remaining fuel volume calculation means, wherein
said alarm issue means (58) also issues an alarm in response to said volume comparison means.

9. The fuel management system according to claim 1, wherein, immediately after said working machine (1) starts and immediately after said working machine (1) stops, said tank contents amount measurement means (11B) measures the amount of said contents while said operational value measurement means (11A) measures said operational value.

10. A fuel managing method for a working machine (1), comprising:
a step of measuring an amount of contents in a fuel tank (81) of said working machine (1);
a step of measuring a predetermined operational value related to fuel consumption operation of said working machine (1);
a step of calculating an expected remaining fuel amount, which is an amount of remaining fuel which ought to be present within said fuel tank (81), based on a result of measurement of said operational value;
a step of comparing said amount of the contents which has been measured, with said expected remaining fuel amount which has been calculated; and
a step of issuing an alarm in response to said comparison result.
